(19) United States
(12) Patent Application Publication
(10) Pub. No.: US 2008/0082483 A1
(43) Pub. Date: Apr. 3, 2008

(54) METHOD AND APPARATUS FOR NORMALIZING PROTEIN NAME USING ONTOLOGY MAPPING

(76) Inventors: Joon-Ho LIM, Daejon (KR); Hyun-Chul JANG, Daejon (KR); Jae-Soo LIM, Daejon (KR); Soo-Jun PARK, Seoul (KR); Seon-Hee PARK, Daejon (KR)

Correspondence Address: LADAS & PARRY LLP, 224 SOUTH MICHIGAN AVENUE, SUITE 1600, CHICAGO, IL, 60604, US

(21) Appl. No.: 11/852,378

(22) Filed: Sep. 10, 2007

(30) Foreign Application Priority Data
Sep. 29, 2006 (KR) 10-2006-0095817

(51) Int. Cl. G06F 17/30

(52) U.S. Cl. 707/2; 707/E17.009

(57) ABSTRACT

Provided is a method and apparatus for normalizing a protein name using ontology mapping. A method for normalizing a protein name using ontology mapping, which includes the steps of: a) extracting a protein name from an input of a biological article; b) analyzing a protein code corresponding to the protein name by calculating similarities between the protein name and synonyms of a synonym dictionary created through an ontology; c) classifying protein species information included in the biological article using a predetermined species classification learning model; and d) assigning an ontology identification (ID) created by combining the analyzed protein code and the classified protein species information to the protein name.

### CROSS-REFERENCE(S) TO RELATED APPLICATIONS

The present invention claims priority of Korean Patent Application No(s). 10-2006-0095817, filed on Sep. 29, 2006, which is incorporated herein by reference.

### BACKGROUND OF THE INVENTION

1. Field of the Invention

The present invention relates to a method for normalizing a protein name; and, more particularly, to a method and apparatus for normalizing a protein name using ontology mapping.

2. Description of Related Art

Various methods of recognizing protein information from articles have been developed to allow biologists to rapidly and exactly retrieve or extract desired information from explosively increased biological articles.

Although a protein name can be recognized from a biological article, it is difficult to find out a protein ontology identification (ID) corresponding to the recognized protein name since there are many variants of the recognized protein name.

### SUMMARY OF THE INVENTION

An embodiment of the present invention is directed to providing a method and apparatus for normalizing a protein name using ontology mapping by assigning an ontology identification (ID) to the protein name using information about a protein code and a protein species corresponding to the protein name.

In accordance with an aspect of the present invention, there is provided a method for normalizing a protein name using ontology mapping, which includes the steps of: a) extracting a protein name from an input of a biological article; b) analyzing a protein code corresponding to the protein name by calculating similarities between the protein name and synonyms of a synonym dictionary created through an ontology; c) classifying protein species information included in the biological article using a predetermined species classification learning model; and d) assigning an ontology identification (ID) created by combining the analyzed protein code and the classified protein species information to the protein name.

Herein, the protein code analysis step b) is performed after restoring a full version of the protein name if the protein name is in abbreviated form.

The protein code analysis step b) includes the steps of: b1) creating the synonym dictionary including protein codes and synonym lists corresponding to the respective protein codes; b2) generating term lists for the respective synonyms of the synonym dictionary; b3) creating a synonym-dictionary inverted-index structure using the term lists; and b4) comparing the protein name recognized from the biological article with entities of the synonym-dictionary inverted-index structure so as to assign the protein name a protein code having a highest similarity to the protein name.

In accordance with an aspect of the present invention, there is provided an apparatus for normalizing a protein name using ontology mapping, which includes: a biological article recognizing unit for extracting a protein name and protein species information from an input of a biological article; a synonym dictionary created through an ontology; a protein code analyzing unit for analyzing a protein code corresponding to the protein name by calculating similarities between the protein name and protein names of the synonym dictionary; a species classification analyzing unit for classifying protein species information included in the biological article using a predetermined species classification learning model; and an ontology ID assigning unit for assigning an ontology ID to the protein name, the ontology ID being created by combining the analyzed protein code and the classified protein species information.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a block diagram illustrating an apparatus for normalizing a protein name in accordance with an embodiment of the present invention.

FIG. 2 is a flowchart illustrating a method for normalizing a protein name in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. In drawings, like reference numerals may denote like elements. Detailed descriptions about well-known functions or structures will be omitted if they are deemed to obscure the subject matter of the present invention. Hereinafter, exemplary embodiments of the present invention will now be described with reference to the accompanying drawings.

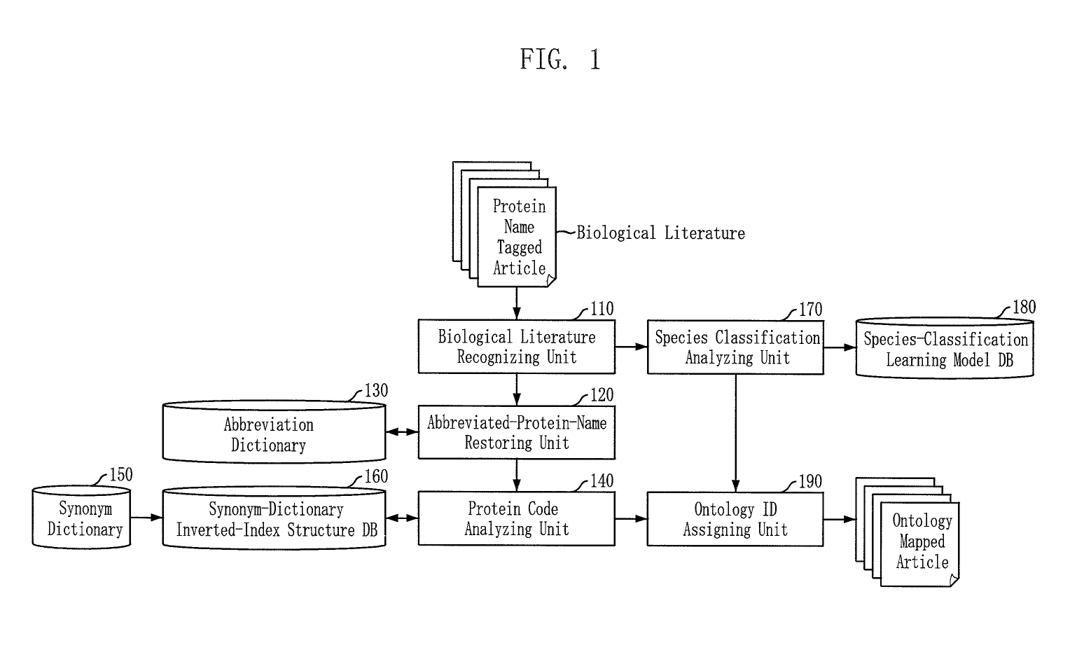

FIG. 1 is a block diagram illustrating an apparatus for normalizing a protein name in accordance with an embodiment of the present invention.

Referring to FIG. 1, the protein name normalization apparatus includes a biological article recognizing unit 110, an abbreviation dictionary 130, an abbreviated-protein-name restoring unit 120, a synonym dictionary 150, a synonym-dictionary inverted-index structure database (DB) 160, and a protein code analyzing unit 140. The biological article recognizing unit 110 extracts a protein name and protein species information from an input of a biological article. The abbreviation dictionary 130 includes sets of abbreviated protein names and original protein names of the abbreviated protein names. If the extracted protein name is in abbreviated form, the abbreviated-protein-name restoring unit 120 restores an original full version of the extracted protein name by searching the abbreviation dictionary 130. The synonym dictionary 150 is created through an ontology. The synonym-dictionary inverted-index structure DB 160 has an inverted-index structure with respect to the synonym dictionary 150. The protein code analyzing unit 140 compares the protein name with entities of the synonym-dictionary inverted-index structure DB 160 to calculate similarities between the protein name and protein codes of the synonym dictionary so as to analyze a protein code corresponding to the protein name.

The protein name normalization apparatus further includes a structure for analyzing protein species. In detail, the protein name normalization apparatus further includes a species-classification learning model DB 180 and a species classification analyzing unit 170. The species classification analyzing unit 170 classifies protein species information included in the biological article using the species-classification learning model DB 180.

The protein name normalization apparatus further includes an ontology ID assigning unit for assigning an ontology ID for the protein name by combining the analyzed protein code and the classified protein species information.

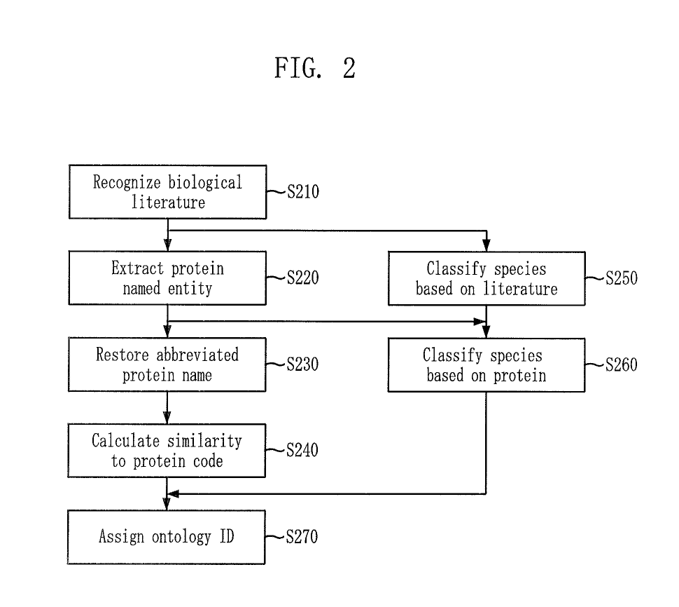

FIG. 2 is a flowchart illustrating a method for normalizing a protein name in accordance with an embodiment of the present invention. The protein name normalization method will now be described with reference to FIGS. 1 and 2.

Referring to FIG. 2, in the protein name normalization method, protein names are recognized from an input of a biological article in step 210, and the biological article is output after ontology IDs are assigned to the respective protein names in step 270. Since the ontology ID assigned to the protein name is configured with a protein code and a protein species, a protein code and a species are analyzed for the protein name. Then, the analyzed protein code and species are combined as the ontology ID. Each step of the protein name normalization method is described below in detail

<Step 220: Extraction of Protein Names>

In step 220, the biological article recognizing unit 110 receives an electronic biological article and recognizes protein names from the biological article using a name extractor module. Examples of the biological article includes as an electronic patent document available from the United States Patent and Trademark Office, and a paper available from PubMed of a National Center for Biotechnology Information (NCBI). An exemplary result by the name extractor module is shown below.

[symbol]

biological article
Cloning of a novel tumor necrosis factor-alpha-inducible
primary response gene that is differentially expressed in
development and capillary tube-like formation in vitro.
TNF is a proinflammatory cytokine that has pleiotropic
effects on cells and tissues, mediated in large part by
alterations in target tissue gene expression. [symbol]
Result by name extractor module
Cloning of a <NE category=”protein”>novel tumor necrosis
factor-alpha</NE>-inducible primary response gene that is
differentially expressed in development and capillary
tube-like formation in vitro.
<NE category=”protein”>TNF</NE> is a proinflammatory
cytokine that has pleiotropic effects on cells and
tissues, mediated in large part by alterations in target
tissue gene expression.

In the current step, strings corresponding to protein names recognized from the biological article are extracted for ontology mapping. In the above example, “novel tumor necrosis factor-alpha” and “TNF” are extracted.

<Step 230: Restoration of Abbreviated Protein Names>

In step 230, the abbreviated-protein-name restoring unit 120 finds original full protein names of the extracted protein names if the extracted protein names are in abbreviated form.

The protein names extracted in step 220 have to be compared with synonyms of a synonym dictionary 150 created through an ontology for protein code analysis. The protein names extracted in step 220 can be in abbreviated forms. However, the synonym dictionary 150 may not include the abbreviated forms of the protein names. For this reason, when the extracted protein names are in abbreviated forms, the original full names of the extracted protein names should be found for exact protein code extraction. The abbreviation dictionary 130 includes sets of abbreviated protein names and corresponding full protein names. If a protein name extracted from the biological article is the same as an abbreviated protein name of the abbreviation dictionary 130, it is determined that the extracted protein name is an abbreviated protein name. Then, the extracted protein name is replaced with a corresponding full protein name using the abbreviation dictionary 130. If it is determined that the extracted protein name in not an abbreviated protein name, the extracted protein name is replaced.

For example, TNF extracted in step 220 is replaced with “Tumor necrosis factor alpha”.

<Step 240: Calculation of Similarity to Protein Code>

In step 240, the protein code analyzing unit 140 calculates the similarities between the extracted protein names and synonyms of the synonym dictionary 150 created through the ontology for protein code analysis.

A vector-space model of information retrieval is used to calculate the similarities between the protein names recognized from the biological article and the synonyms of the synonym dictionary 150. A synonym having the most similarity with the protein name recognized from the biological article is found from the synonym dictionary 150 through the similarity calculation, and a protein code of the synonym is assigned to the protein name (here, the protein code is a portion of an ontology identification (ID) not containing species information of the ontology ID). The similarity calculation will now be described in more detail.

A. Synonym Dictionary

The synonym dictionary 150 is created based on the ontology by using protein codes and synonym lists respectively corresponding to the protein codes. In terms of information retrieval, the synonym dictionary 150 corresponds to a collection of articles to be retrieved, each protein code corresponds to each individual article to be retrieved, and synonyms of each protein code corresponds to contents of each article.

B. Generation of Term List for Each Synonym

Prior to the application of the vector-space model to the calculation of the similarities between the synonyms and the protein names (queries) recognized from the biological article, a term list is generated for each synonym to express various forms of protein names that can be present in the biological article. The term list is defined by all possible sub-strings of tokens. For example, a term list of “amyloid beta protein” is {amyloid, beta, protein, amyloid beta, beta protein, amyloid beta protein}.

C. Vector-Space Model

Indicators such as a term-frequency tf and an inverse-document-frequency idf are defined to apply the vector-space model to the similarity calculation. The term-frequency tf, the inverse-document-frequency idf, and a weight for each term is defined by Eq. 1 below.

$${tf}_{term} = \frac{term - length}{synonym - length} \\ {idf}_{term} = log ( \frac{\# of total protein code}{\# of protein code containing term} ) \\ {weight}_{term} = {tf}_{term} \times {idf}_{term} \qquad Eq . 1$$

In Eq. 1, the term-frequency tf is an indicator representing a correlation degree between and a given term and a corresponding protein code, and the inverse-document-frequency idf is an indicator representing a distinctiveness of a given term with respect to the whole protein codes. For example, in the case of a term list of “amyloid beta protein”, the term-frequencies tf of amyloid, beta, and protein are ⅓; the term-frequencies tf of amyloid beta and beta protein are ⅔; and the term-frequencies tf of amyloid beta protein is 3/3. That is, the correlation degree between a term and a protein code increases in proportion to the length of the term. The inverse-document-frequency idf of a term relates to a protein code ratio as shown in Eq. 1. For example, the term “amyloid” is included in a small number of term lists of protein codes as compared with the term “beta”. Therefore, the term “amyloid” has a higher distinctiveness for distinguishing a protein code than the term “beta”. Thus, the inverse-document-frequency idf of the term “amyloid” is higher than that of the term “beta”. The weight of a term is calculated by multiplying the term-frequency tf and the inverse-document-frequency idf of the term.

D. Generation of Synonym-Dictionary Inverted-Index Structure

The synonym-dictionary inverted-index structure DB 160 is generated for using the vector-space model. For this, a term list is created for each synonym of the synonym dictionary 150, and the term-frequency tf, the inverse-document-frequency idf, and the weight of each term of the term list are calculated. The weights of the terms are stored in the synonym-dictionary inverted-index structure DB 160 for each protein code. Then, protein codes related with each token of the term are listed, and the protein code lists are stored in the synonym-dictionary inverted-index structure DB 160.

E. Calculation of Protein Name Similarity

A protein name recognized in the biological article is used as a query of the vector-space model. A term list is generated for each protein name like in the case of the synonym dictionary 150, and the term-frequency tf of each term is calculated. Then, the weight of the term is calculated using the calculated term-frequency tf by setting the inverse-document-frequency idf of the term to 1.0. The similarity of each token of the protein name is calculated for the protein code (pcode) lists stored in the synonym-dictionary inverted-index structure DB 160 using Eq. 2 below.

$$sim ( pcode , query ) = {\sum }_{term ∈ query} {weight}_{pcode , term} \times {weight}_{query , term} \qquad Eq . 2$$

The similarity calculation equation (Eq. 2) differs from a conventional vector-space model in that document-length normalization is not performed. Since a protein code having a relative many synonyms appears more frequently than a protein code having fewer synonyms when protein codes are extracted, the document-length normalization is not performed.

F. Assignment of Protein Code to Protein Name

A protein code, which is determined using the synonym-dictionary inverted-index structure DB 160 as the most similar protein code to a protein name recognized from the biological article, is assigned to the protein name. When there are a plurality of most similar protein codes, a protein code including an essential word such as a “receptor” is assigned to the protein name prior to the others, or a protein code already assigned for another protein name of the same biological article is assigned to the protein name prior to the others.

<Step 250: Classification of Species Based on Articles>

In step 250, the species classification analyzing unit 170 performs species classification based on articles as a pre-step for classifying species of protein names recognized from the biological article. Since most articles disclose the scientific name of a species used for an experiment, the species of proteins contained in a article can be easily recognized by classifying species based on articles. A species classification learning model DB is a trained model of a machine learning technique for species classification, and it is trained using articles of ontology, which are classified based on species. In this way, the species information of an article input is classified using the learning model. Since one or more species can be cited in a article, one or more species can be classified for a article in this step.

<Step 260: Classification of Species Based on Proteins>

In step 260, the species classification analyzing unit 170 performs species classification based on proteins according to the result of step 250. That is, when the result of step 250 is one species, all the protein names of the biological article belong to the species. On the other hand, when the result of step 250 is two or more species, each of the protein names of the biological article belongs to one of the species. In the later case, the locations of the scientific names of the two or more species in the biological article are compared with the locations of the protein names in the biological article according to a preset rule so as to classify the protein names according to the two or more species.

<Step 270: Assignment of Ontology ID>

In step 270, the ontology ID assigning unit 190 assigns an ontology ID to each protein names using the protein code information recognized in the similarity calculation step 240 and the protein species information recognized in the species classification steps 250 and 260.

In this way, the protein names are normalized using the ontology IDs, and the normalized protein information is recorded in the biological article as an output. The normalized protein information can recorded in the biological article as shown below.

[symbol]

Normalized protein information (when the normalization
is based on Swiss-Port ontology)
Cloning of a <NE category=”protein”
accession=”TNFA HUMAN”>novel tumor necrosis factor-
alpha</NE>-inducible primary response gene that is
differentially expressed in development and capillary
tube-like formation in vitro.
<NE category=”protein” accession=”TNFA HUMAN”>TNF</NE> is
a proinflammatory cytokine that has pleiotropic effects on
cells and tissues, mediated in large part by alterations
in target tissue gene expression.

In the example of the normalized protein information, the protein names are normalized by Swiss-Port ontology into “TNFA_HUMAN” using the extracted protein code (TNFA) and the species information (HUMAN). If the protein names are normalized by Entrez-Gene ontology, the protein names are normalized into “7124_{—}9606” using an extracted protein code (7124) and species information (9606, Homo Sapiens).

According to the present invention, protein names read from a biological article are normalized into ontology IDs by ontology mapping so that the protein names contained in the biological article can be exactly recognized. Therefore, biologists can search for articles containing desired proteins more exactly as compared with the case of using a conventional search method using character strings. Furthermore, instead of a protein name non-normalized protein-protein interaction network, an ontology ID based normalized protein-protein interaction network can be established using an interaction recognition method for biological articles.

While the present invention has been described with respect to the specific embodiments, it will be apparent to those skilled in the art that various changes and modifications may be made without departing from the spirit and scope of the invention as defined in the following claims.

What is claimed is:

1. A method for normalizing a protein name using ontology mapping, comprising the steps of:
a) extracting a protein name from an input of a biological article;
b) analyzing a protein code corresponding to the protein name by calculating similarities between the protein name and synonyms of a synonym dictionary created through an ontology;
c) classifying protein species information included in the biological article using a predetermined species classification learning model; and
d) assigning an ontology identification (ID) created by combining the analyzed protein code and the classified protein species information to the protein name.

2. The method of claim 1, wherein the step b) is performed after restoring a full version of the protein name if the protein name is in abbreviated form.

3. The method of claim 1, wherein the step b) includes the steps of:
b1) creating the synonym dictionary including protein codes and synonym lists corresponding to the respective protein codes;
b2) generating term lists for the respective synonyms of the synonym dictionary;
b3) creating a synonym-dictionary inverted-index structure using the term lists; and
b4) comparing the protein name recognized from the biological article with entities of the synonym-dictionary inverted-index structure so as to assign the protein name a protein code having a highest similarity to the protein name.

4. The method of claim 3, wherein if a plurality of protein codes have a highest similarity to the protein name, one of the protein codes that includes a predetermined essential word is assigned to the protein name prior to the other protein codes, or one of the protein codes that is analyzed for another protein name of the biological article is assigned to the protein name prior to the other protein codes.

5. The method of claim 1, wherein the step c) is performed by classifying registered articles of the ontology based on species to create a database and using the database as a learning model database of a machine learning method.

6. An apparatus for normalizing a protein name using ontology mapping, comprising:
a biological article recognizing unit for extracting a protein name and protein species information from an input of a biological article;
a synonym dictionary created through an ontology;
a protein code analyzing unit for analyzing a protein code corresponding to the protein name by calculating similarities between the protein name and protein names of the synonym dictionary;
a species classification analyzing unit for classifying protein species information included in the biological article using a predetermined species classification learning model; and
an ontology ID assigning unit for assigning an ontology ID to the protein name, the ontology ID being created by combining the analyzed protein code and the classified protein species information.

7. The apparatus of claim 6, further comprising:
an abbreviation dictionary including sets of abbreviated protein names and original protein names of the abbreviated protein names; and
an abbreviated-protein-name restoring unit for restoring an original full version of the protein name by searching the abbreviation dictionary if the protein name is in abbreviated form.
